(19) United States
(12) Patent Application Publication
(10) Pub. No.: US 2005/0044527 A1
(43) Pub. Date: Feb. 24, 2005

(54) Code Units based Framework for domain- independent Visual Design and Development

(75) Inventor: Gerardo Arayata Recinto, Union City, CA (US)

Correspondence Address: Gerardo Recinto, 33 Union Square #417, Union City, CA, 94587, US

(73) Assignee: Gerardo Arayata Recinto, Union City, CA (US)

(21) Appl. No.: 10/604,864

(22) Filed: Aug. 22, 2003

(51) Int. Cl. G06F 9/44

(52) U.S. Cl. 717/109

(57) ABSTRACT

This framework provides for the creation, (re)use, and management of Domain specific Code Units as basic building block for Domain neutral Visual Programming environments. Code Units are Application Programming Interfaces (API). Users create and maintain Code Units definitions (including implementations, visual representations and/or standard Model representations for Model based development) for specific programming Domain and they or others can then use or extend the created Code Units both through the code and/or the provided visual programming on the said Domain. The semantics of “instrumented”, thus fully integrate-able to Visual environment Code Units applied to different programming Domains provide support for very rich, location transparent (i.e.—both local and remote “discovered” Code Units are supported), easy to implement and minimal “usage” footprint Visual Design and Development, two-way code generation, and generated program execution, representations of Code Units instances as Visual Entities and Models, Model Transformations and Model Analyses.

### BACKGROUND OF INVENTION

Software development history shows that there is an ever increasing need towards higher levels of abstraction. Levels of abstractions allow developers to focus on solving problems at hand rather than on low-level implementations' details (i.e. the “plumbing” side of development). However, it is almost impossible (and/or extremely difficult) to provide necessary high-level abstractions to all known programming areas or domains, much more, provide the necessary Visual or Model based development to each, for rapid development support. Thus, a framework that facilitates development of high-level abstractions (e.g. APIs) for any programming domain that produce of which, serves as reusable and/or extendable functions (artifacts) that are the basic unit or element of Visually created programs of the Visual development environment is in dire need.

### SUMMARY OF INVENTION

A framework that provides Code Units development for any programming domain that is used as “template objects with their functions” of the framework's Visual development environment. The framework facilitates support for Code Units implementation(s) on different platforms and their programming language(s).

Framework comes with Visual development environment where users create and/or maintain programs visually by reusing and instantiating (different) Code Units artifacts. An environment implementation can be supporting 2-way program/code generation based on visually created program representation (i.e. Code Units artifacts “instances” to execute, their required parameters and their execution sequence), execution and debugging. Furthermore, some environment implementation may even provide visual extendibility to the Code Units that are then available as artifacts of Visual design and programming.

Framework provides Code Units instrumentation mechanism necessary for the Visual development environment to discover them.

Framework provides some form of execution mechanism of user defined visually created program(s).

Framework provides management and mapping to visual representation of user defined Code Units and management of visually created programs.

### BRIEF DESCRIPTION OF DRAWINGS

FIG. 1 is a high level diagram showing a typical implementation of the framework. Instrumentation and Execution Engine is used by Visual Development Environment to process available Code Units. Visual Development Environment in this implementation represents and displays Code Units visually as Template Diagrams. It allows creation of Design Diagrams and Visual Programs from Template Diagrams.

FIG. 2 shows Code Units implementation for specific programming Domains and how they get to be reflected and provide rich diagramming features to the Visual Modeling and Programming of the Visual Environment. It shows that each Code Units implementation provide corresponding set of Template Diagram, Design Diagram and Visual Programming to the Visual Environment. The more Code Units there are, the more features and scenarios are available for Visual Modeling and Programming on the Environment.

FIG. 3 shows breakdown of Code Units to show them being APIs and items of each Unit are the high-level functions catering for the programming Domain they are built for.

FIG. 4 is a diagram showing Framework's Instrumentation and Execution Engine to be versatile so as to be implement and extend able to support Code Units implementation on all available platforms now and the future.

FIG. 5 shows how the Framework supports both local and remote Code Units discovery and processing and is versatile to be implement and extend able to support current and future “Management and Instrumentation” protocols.

FIG. 6 is a State-Transition diagram showing the different stages (states) of Visual Rapid Application Development using the Framework.

FIG. 7 is a State-Transition sub-diagram showing different hi-level stages of how to enable discovery and/or processing of Remote Code Units via different “Management and Instrumentation” protocols.

### DETAILED DESCRIPTION

Developers were and are still in great need of Software Engineering tools that make their life easier. The kind of tools that allow them to do their job easier, faster and more accurately at the same time allows them to give the right amount of focus on the Design, thus, yielding higher Quality and more Efficient Computerized Systems. Recently, Rapid Application Development (RAD) had revolutionized Software Engineering. But still, it remains that with the almost infinite number of areas needing Computerization (called as programming Domain in this document), RAD barely touched solving the real problem, as most or all of the current tools available just cater for specific area or Domain (e.g.—Forms designer is a Visual designer tool geared only for User Interface related design and development). Code Units based Framework for Visual Design and Development addresses the problem in its entirety and brings to the arms of Software Engineers the needed tool and finally, it will be possible and practical to Computerize almost any programming Domains known, if and when needed. This as the Framework□s main feature is full extend ability, portability and flexibility allowing it to address any programming Domain□s RAD development.

User(s) implement Code Units to abstract into high-level functions or API a specific programming Domain. Implementation is written on a platform supported by the Framework or on a platform yet to be supported. In the latter case, user then will need to extend the Instrumentation and Execution Engine of the Framework to support the new platform so (s)he may implement the Code Units on it. User can write the Units on a supported language of the supported platform. When Code Units were written to apply Instrumentation and Execution Engine Instrumentation attributes or equivalent mechanism, Instrumentation and Execution Engine allows any application that uses the Framework to be able to discover the Code Units, process their information and/or execute any of the available Functions of the Code Units. During Units development, user can optionally provide the necessary display information for each of the Code Units class and/or each of the Units Class□ Items. When provided, any application or Visual Environment that uses the Framework can then use the said information for Visual Display, etc□

After finishing up development of the Code Units, it is ready for loading and reuse in the Visual Design and Development Environment. User(s) loads up the Code Units on the Environment into Template Diagram(s). In this step, the environment or Application uses Instrumentation and Execution Engine for the discovery and processing of Code Units. Each Code Unit class or group is assigned a Template Diagram and each item of the Unit Class is assigned its icon or Visual Display artifact and its needed Attributes. If Display information, events and other user provided custom data and interfaces are provided, the Environment processes that and displays or provides the equivalent UI representation and behavior that match the user provided info.

User(s) can also load other types of Code Units local and/or remote. Example, Instrumented Objects exposed by current Instrumentation protocols such as WBEM, SNMP will be loadable also and treated as Code Units, e.g. □ loaded into its Template Diagrams. Other types of Protocols can be supported by extending the Framework□s Code Agent to support and understand discovery and processing of Code Units using the custom protocol.

During this loading stage, the Environment can offer Code Units Functions□ □signature□ (e.g. □ name, return and parameter(s) value and type) validation and correction for those Units that were previously loaded and have been used in any Design and Visual program created. Such feature can be done as the previous Code Units□ information can be compared easily with the new ones gathered from the updated version.

User(s) can create Design Model(s) from Template Diagram(s) by instantiating Item(s) of the Templates. An example implementation is user can drag-drop an item from Template Diagram onto the Design Work Area. The act of dropping the item generates the necessary information and code internally enough to recreate the Design and/or to execute it. Same is true with Visual Program. The difference between a Design and a Visual Program lies on the context of the Code Units Item(s) being instantiated. Very High level Items of Code Units can be represented well as Design items and otherwise, as Visual Program items. The categorization of that is implementation specific per Application or Environment flavor. In some cases, such implementation may allow user freedom to categorize Code Units and their Items whether as Design or Visual Program templates or template elements. In some other implementations, it may not matter or not a feature. In further implementations, Visual Design and/or Modeling may not be there, Application may just reuse the Framework for discovery, instantiation of Code Units and execution of their Item(s).

Created Design Diagrams and/or Visual Programs can be executed and/or debugged in the environment. Optionally, a Code Generator can be implemented and used to generate Code from the Visual Program and/or Design Diagrams. Above discusses an embodiment of a possible type of Applications (including Visual Environments) that can be developed that takes advantage or can be part of the Code Units based Framework. Other embodiments may contain more or less features, significant difference in functionalities or capabilities and sequence of usage of the different features of the Framework may vary.

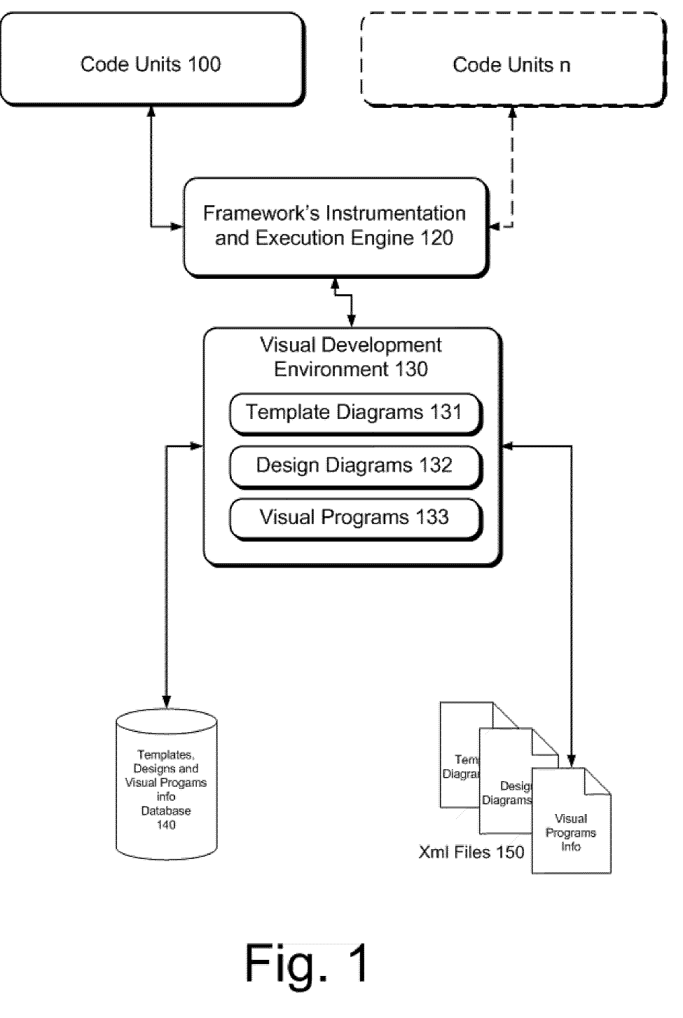

FIG. 1 is a high level diagram showing a specific embodiment of the framework. Instrumentation and Execution Engine 120 is used by Visual Development Environment 130 to discover and process available Code Units 100. Visual Development Environment 130 in this implementation represents and displays Code Units 100 visually as Template Diagrams 131. It allows creation of Design Diagrams 132 and/or Visual Programs 133 from Template Diagrams 131. All data created on the Environment for each Workspace such as Template Diagrams 131, Design Diagrams 132, Visual Programs 133 are optionally saved or loaded to or from their Database repository, Xml Files and/or other medium(s).

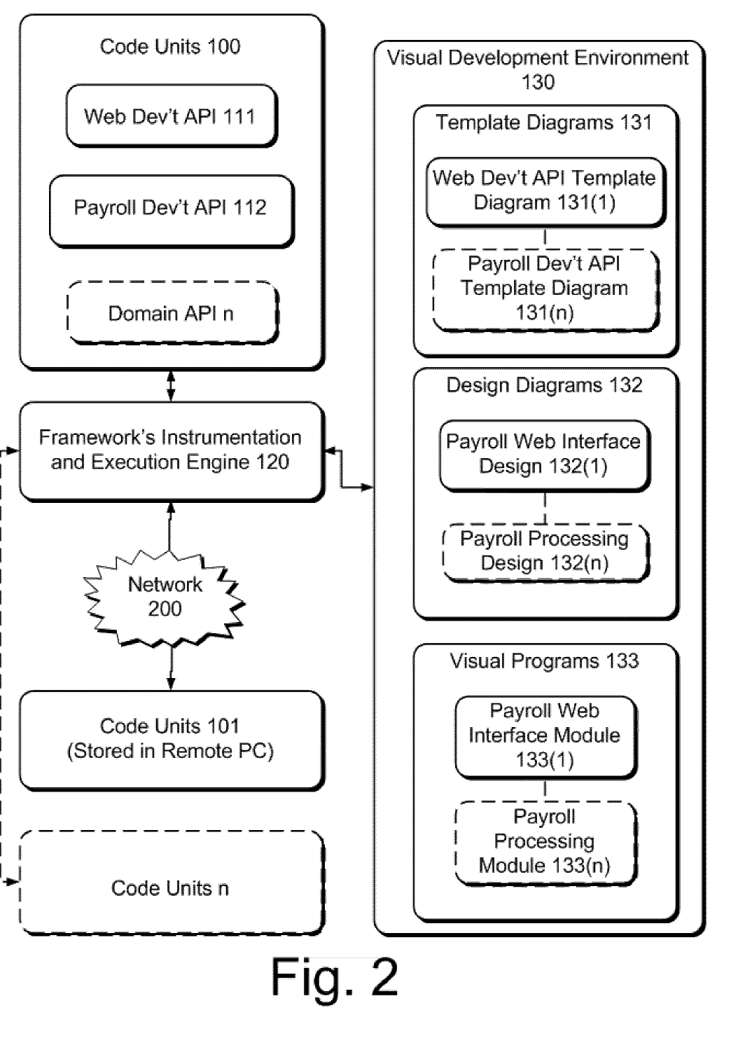

FIG. 2 shows Code Units 100 implementation for specific Domains, Web Development API 111 and Payroll Development API 112, and how they get to be reflected in diagramming features to the Visual Modeling and Programming of the Visual Environment 130. It shows that each Code Units 100 implementation provide corresponding set of Template Diagram 131, Design Diagram 132 and Visual Programming 133 to the Visual Environment 130. The more Code Units 100 there are, the more features and scenarios are available for Visual Modeling and Programming on the Environment 130.

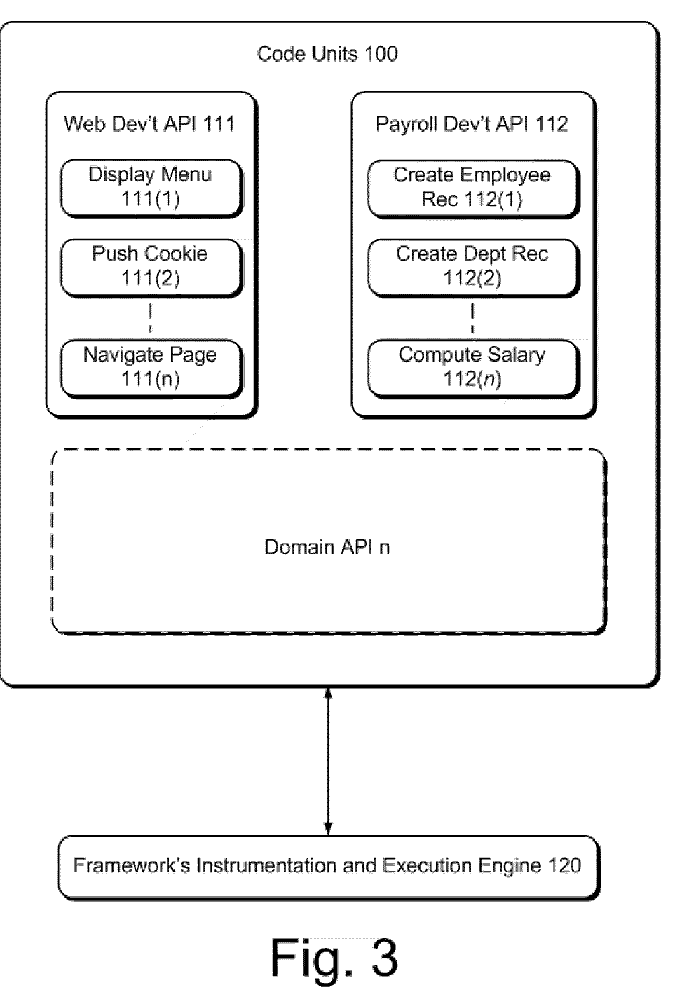

FIG. 3 shows breakdown of Code Units 100 to show them being APIs and items of each Unit are the high-level functions catering for the programming Domain they are built for. For illustration purposes, sample Web Development API 111 provides the necessary high-level functions such as Display Menu 111(1), Push Cookie 111(2) and others (Navigate Page 111(n)) of “Web Development” programming domain. Sample Payroll Development API 112 provides the necessary high-level functions such as Create Employee Record 112(1), Create Department Record 112(2) and others (Compute Salary 112(n)) of “Payroll Development” programming domain.

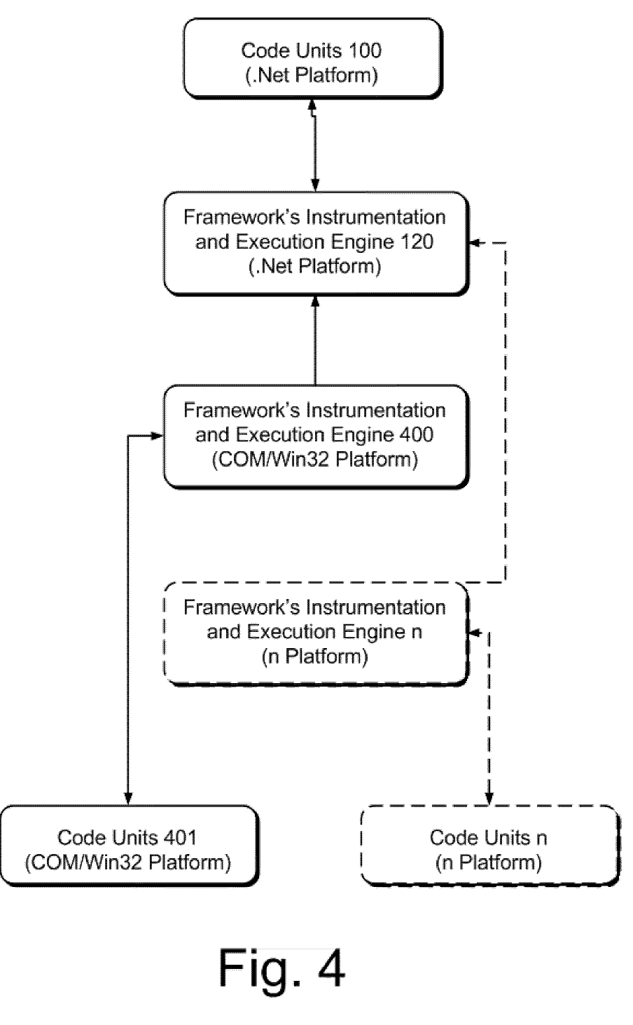

FIG. 4 is a diagram showing Framework□s Instrumentation and Execution Engine 120, 400, . . . n to be versatile so as to be implement and extend able to support Code Units 100, 401, . . . n implementation on all available platforms now and the future (Microsoft's .Net, COM/WIN32, . . . n).

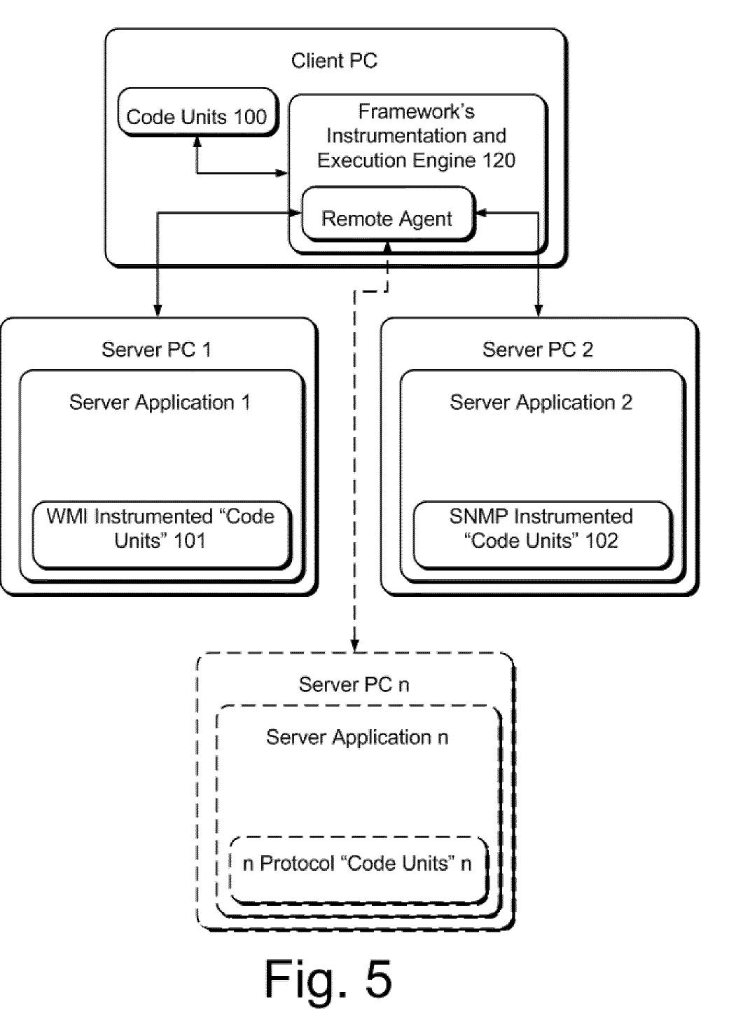

FIG. 5 shows how the Framework (Framework's Instrumentation and Execution Engine 120 and (Remote) Code Agent) supports both local (Code Units 100) and remote Code Units (WMI Instrumented Code Units 101, SNMP Instrumented Code Units 102, . . . n Protocol Code Units n) discovery and processing and is versatile to be implement and extend able to support current and future □Management and Instrumentation□ protocols.

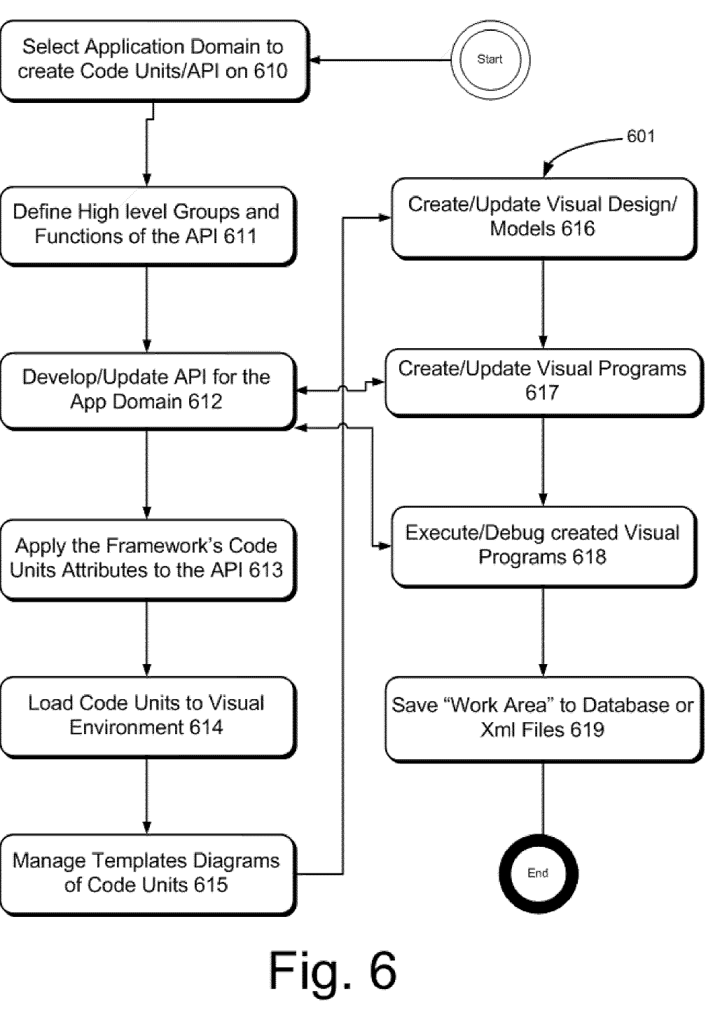

FIG. 6 is a State-Transition diagram showing the different stages or states of Visual Rapid Application Development using the Framework. Users start with selecting a specific programming Domain they want to work on in 610.

User(s) define and create different categories or groups and function(s) comprising each group to form the different Code Units of the selected programming Domain's API (611).

User(s) develop and/or update equivalent Application Programming Interfaces for the different categories and their functions created in 611. User(s) encapsulate in the API the low-level details of the programming logic for the different categories and functions mentioned (612).

During or after API development, user(s) apply the necessary Code Units Framework's Attributes to “Instrument” the API (613). Doing this step makes the “Instrumented” API program elements such as classes and each class' functions and members available within the Visual Programming Environment. Those API programming elements not Instrumented are then not available as loadable units inside the environment.

After creating the Instrumented API, user(s) load them to the Visual Environment so they or others can use the Code Units to design and/or develop models and/or programs visually (614). Code Units are displayed visually into their corresponding “template diagrams”.

User(s) optionally manage the template diagrams of Code Units to their desired liking for easy usage in their visual design and programming (615).

User(s) create or update Visual Design and/or Models (616). They can create new designs or update existing ones from all loaded Code Units in the environment. The environment may optionally offer Design and Models validation versus their Code Units' definitions to make it easy for user(s) to sync them up.

User(s) create or update Visual Programs (617). They can create new programs or update existing ones visually from all loaded Code Units in the environment. In an implementation, the visual program designer will support feature that combines source code editing where needed to provide needed flexibility to programmers to express their program logic as some programmers may feel like direct code editing as more expressive of their custom program logic. Some Visual designer implementation(s) may also support program structures, program flow(s) visual controls allowing user to fully program visually as even the logic flows and necessary custom program structure(s) are available as drag-droppable controls having customizable attributes and properties. Control Event handlers may also be supported in either or both direct source code editing and/or Event Visual Control.

User(s) can execute and/or debug their visually created programs at any point in their development (618).

User(s) can save the work environment or work area to Code Units and Designs and Programs repositories (619). Repositories in some implementation are Xml files and in other implementations are tables in a database and in further implementations, user have the option whether to save work area in their desired or all repositories destination available.

User(s) exit or quit the environment.

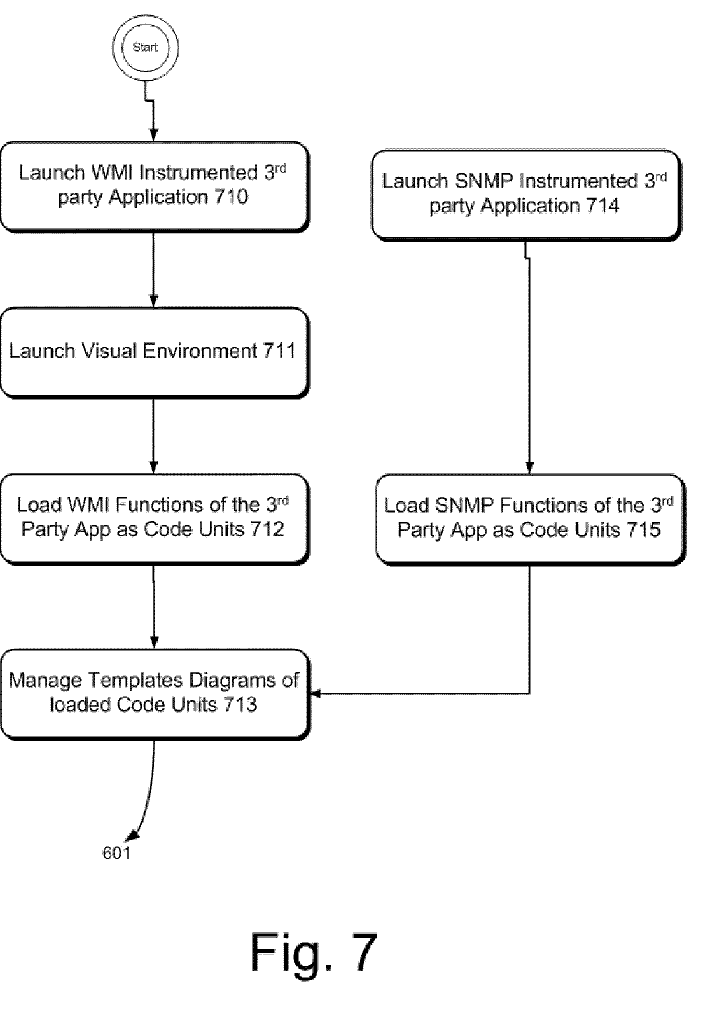

FIG. 7 is a State-Transition diagram detailing different stages of discovery and/or processing of Remote Code Units via different standards based and proprietary □Management and Instrumentation□ protocols.

User(s) launch WMI Instrumented third party Application (710). This step makes the Instrumented instances to be alive and their exposed (via WMI) events, data and/or functions to be auto-discovered and thus, loadable in the Visual Environment.

User(s) launch Code Units Framework's Visual Environment implementation (711) in preparation to auto-discover and load the WMI Instrumented interfaces of the application launched in 710.

For the Code Units to be usable in the Visual Environment, user(s) load the WMI Instrumented interfaces of the third party application launched in 710 (712). The Visual Environment uses the Code Units Framework's Code Agent to auto discover the WMI Instrumented interfaces (objects, data and events).

The Visual Environment load the Code Units into their default templates in which, user(s) can manage for their template display customization (713). Some user(s) will find this step as a very convenient feature to make their Design and/or Visual Programming work using the templates easier and efficient per UI navigation.

Optionally, user(s) can also use their or other(s) written third party Application(s) using SNMP (and/or other yet to be defined Instrumentation) protocol(s). Similar to 710, user(s) launch the SNMP Instrumented third party app to make the Instrumented classes' instances' interface available (714).

Visual Environment can auto-discover the SNMP Instrumented objects, data and traps similar to how it can do such using WMI (715). Code Agent will have SNMP protocol plugin that will allow it to understand SNMP protocol and how to discover callable functions, data and traps of the third party app.

User(s) then can resume or proceed working on their Visual design(s) and program(s) and start instantiating or using the newly loaded Code Units in their modeling and programming work.

Although above discussions may pertain to specific application(s) of Code Units based Framework, the concepts of the Framework is applicable or usable to any number and kind of Software Design and Development.

1. A framework for use in Code Units development specially useful in Visual Programming development environments, the framework comprising: Code Units authoring engine; a plurality of Code Units definitions; a plurality of implementations for each Code Units definition; Code Units Visual representation engine; Domain specific Code Units Visual programming interfaces.

2. The framework of claim 1 wherein user-defined Code Units' implementations are the high-level API of a programming domain.

3. The framework of claim 1 wherein Code Units definitions have user-definable and assignable Visual representations and/or Model entities for use for either or both Visual Programming and/or Model based developments.

4. The framework of claim 1 wherein user-defined (different) Domain dependent Code Units implementation (API) instances can comprise partly or in whole user-defined visually created program(s).

5. The framework of claim 1 wherein sets of Code Units for different Domains can be (re)used and/or combined to form the available “templates” for Visually creating programs encompassing different programming Domains.

6. The framework of claim 1 wherein implemented Code Units can be visually extended and/or combined to provide new functionalities thereby, yielding new set(s) of Code Units.

7. The framework of claim 1 wherein framework implementation facilitates Domain dependent Code Units authoring by providing the standard “contract” and relevant Authoring engine necessary for integrating support for the being authored Domain.

8. The framework of claim 1 wherein framework facilitates some form of validation of visually created designs and programs providing visual designers and programmers a “before execution time” tool capability to debug and/or correct visual artifacts' Attributes or parameters and to synchronize to reflect changes done to the Code Units API.

9. Framework has “extensible” instrumentation mechanism that facilitates (automatic) discovery of available Code Units from Applications, Binaries including code libraries and/or Code.

10. The framework of claim 8 wherein the framework's instrumentation mechanism provides automatic discovery of available Code Units from Remote application(s).

11. The framework of claim 8 wherein the framework's instrumentation mechanism's Remote Code Units automatic discovery is extendible and/or customizable to support current and future different Standards and non-Standards based instrumentation protocols.

12. The framework of claim 8 wherein the framework's instrumentation mechanism provides automatic discovery of available Code Units from dynamically loaded Remote binaries and/or code libraries via Remote application(s).

13. The framework of claim 8 wherein the framework's instrumentation mechanism is fully or partially modifiable to support different instrumentation mechanisms and methods.

14. The framework of claim 8 wherein the framework's instrumentation mechanism is extend able to support different instrumentation mechanisms and methods.

15. Code Units implementations can appear in different programming languages and platforms, be of different formats or code structure per language and platform implementation.

16. The framework of claim 14 wherein the framework provides mechanism to support integration of Code Units implementation(s) on different platform(s) and programming language(s) to the Visual and/or Model based development application(s).

17. The framework of claim 14 wherein the framework provides mechanism to support user definable and customizable Visual representation of each item of the Code Units.
